(19) United States
(12) Patent Application Publication
(10) Pub. No.: US 2020/0023285 A1
(43) Pub. Date: Jan. 23, 2020

(54) DISTILLATION PROCESS AND METHOD

(71) Applicant: Heng Khun, Calgary (CA)

(72) Inventor: Heng Khun, Calgary (CA)

(21) Appl. No.: 16/039,998

(22) Filed: Jul. 19, 2018

(51) Int. Cl. B01D 1/22; B01D 1/28; B01D 5/00

(52) U.S. Cl. CPC B01D 1/22; B01D 1/2818; B01D 3/10; B01D 5/0063; B01D 5/009

(57) ABSTRACT

A distillation system used for a distillation process including a distillation chamber having a curved and contoured body, a tube for continuous filling of a liquid solution to be distilled, and a drain hole in a bottom of the body configured for removal of concentrated semi-solid contaminants, and multiple layers of sheets of a flexible material. As designed the curved and contoured body shape of the distillation chamber coupled to the cooled surface (near a point of vapors condensation) creates negative pressure that drives the distillation process and the negative pressure built into the distillation system facilitates and increases distillation and evaporation rates.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### Technical Field

The present invention relates generally to the field of distillation processes of existing art and more specifically relates to a distillation process and method.

### Related Art

In modern times many individuals and groups of people have become serious about preserving the environment for future generations. Nuclear power for example is a very efficient means for providing energy however the by-products may be harmful if not properly dealt with. It is desirable to keep water, soil and air substantially free from pollutants, or if polluted to return them to a substantially pure state. Distillation is the process of separating the components or substances from a liquid mixture typically by selective boiling and condensation. Distillation may result in essentially complete separation (nearly pure components), or it may be a partial separation that increases the concentration of selected components of the mixture. An efficient and effective means for distillation is desired.

Canadian Pat. No. 2,543,020 to Sameul Okwaja Otukol relates to a distillation system and process for distilling contaminated water. The described distillation system and process for distilling contaminated water includes a filtering system for filtering contaminated water including an evaporation chamber for receiving the contaminated water. The evaporation chamber includes (i) a vessel for absorbing the contaminated water; (ii) a plurality of heat conductive pipes extending through the vessel for delivering the contaminated water to the vessel; and (iii) a heat source for heating the plurality of heat conductive pipes for evaporating the contaminated water absorbed by the vessel and causing the at least one contaminant to be retained by the vessel. A condensation chamber is connected to the evaporation chamber for receiving the evaporated water for condensing and producing purified water in liquid form. A storage device is connected to the condensation chamber for storing the purified liquid water.

### SUMMARY OF THE INVENTION

In view of the foregoing disadvantages inherent in the known distillation process art, the present disclosure provides a novel distillation process and method. The general purpose of the present disclosure, which will be described subsequently in greater detail, is to provide a distillation process and method of using multiple cloth-like layers such that evaporated water does not contain contaminates.

A distillation system used for a distillation process is disclosed herein comprising: a distillation chamber and a vapor capture chamber having a curved and contoured body, at least one tube for continuous filling of a liquid solution to be distilled, and at least one drain hole in a bottom of the body configured for removal of concentrated semi-solid contaminants, and multiple layers of sheets of a flexible material. As designed the curved and contoured body shape of the distillation chamber coupled to the cooled surface (near a point of vapors condensation) creates negative pressure that drives the distillation process and the negative pressure built into the distillation system facilitates and increases distillation and evaporation rates.

The curved and contoured body of the distillation chamber allows for a convection current to be focused through the cooled (chilled) surface for rapid condensation which creates a vacuum. The drain hole at the bottom of the body goes into an insulator/container to solidify waste. The multiple layers of sheets of a flexible material (preferably cloth or cloth-like material) are just above a boiling-water-interface as the cooled surface(s) atomize water molecules such that the evaporated water vapor does not contain the contaminants.

According to another embodiment, a method of distillation using multiple cloth-like layers such that evaporated water does not contain contaminates using a distillation system in a distillation process is also disclosed herein. The method comprises the steps of: first providing a distillation system, next atomizing a solution, and creating a negative pressure which speeds up the distillation process to increase relative efficiency of the distillation; wherein the distillation system is suitable for use in alcohol productions, heavy metals remediation, smock remediation, industrial wastes and tail pond remediation and alternately water purification.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a distillation process and method, constructed and operative according to the teachings of the present disclosure.

FIG. 1 is a view of the distillation system during an ‘in-use’ condition in a distillation process, according to an embodiment of the disclosure.

FIG. 2 is another view of the distillation system of FIG. 1, according to an embodiment of the present disclosure.

FIG. 3 is a view of the distillation system of FIG. 1, according to an embodiment of the present disclosure.

FIG. 4 is another view of the distillation system of FIG. 1, according to an embodiment of the present disclosure.

FIG. 5 is a flow diagram illustrating a method of use for the distillation process and method of using multiple cloth-like layers such that evaporated water does not contain contaminates, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a distillation process and more particularly to a distillation process and method as used to improve the removal of contaminates from any solutions.

Generally, the distillation process disclosed herein uses multiple layers of sheets of cloth (or similar material) just above the boiling water interface as the surfaces to atomize the water molecules such that the evaporated water vapor does not contain contaminants. The negative pressure built into the distillation system facilitates and increases the distillation and evaporation rates. The curved and contoured shape of the chamber coupled to the cooled surfaces near the point of vapors condensation creates the negative pressure that drives the distillation process. The distillation chamber contains a tube for continuous filling of the liquid and a small drain hole in the bottom is used for the removal of the concentrated semi-solid contaminants. The system offers the following advantages: 1. It removes contaminants from liquid or semi liquids; 2. Contaminants become a solid for easy disposal; 3. The system is able to run continuously.

Remediation/distillation for evaporating contaminants from a solution; the user is able to atomize the water so he/she can spate the contamination. The first part of the process is to atomize the solution, the second part is creating the negative pressure that speeds up the process making it more efficient. The curved contour of the chamber allows for a convection current to be focused through a chilled surface for rapid condensation which creates a vacuum to increase the rate of evaporation to further increase efficiency and volume of material to be remediated. The hole at the bottom of the chamber goes into an insulator/container to solidify the waste. A continuous feeding tube allows new material to be remediated into the distillation system and the current creates a continuous self-flow, a constant system.

The cloth (layers) described herein do not capture contaminants; the first layer acts to moderate the evaporation phase of the distillation process; a hard boil can be used without having any contaminants pass through from bursting/splashing effects of bubbles in a hard boil. The cloth layers also amplify the distillation such that adding layers of cloth acts like repeated distillation for example two layers is effectively equivalent to double distillation, three to triple, and the like. As a consequence, the system has single water molecules passing through, which prevents the formation of water molecule clusters in the vapor, which could otherwise preserve ionic effects and trap contaminants in the clusters (lppb or lower). The negative pressure drives down the boiling temperature, allowing an even more vigorous evaporation with cloth layers in place, again increasing throughput for the system. Needed is that the solution input and contaminant removal keep the entire system running continuously such that the whole system works synergistically to be ‘greater than the sum of the parts’. The present invention is applicable for use in industrial scales for processes like alcohol productions, water purification, and the like.

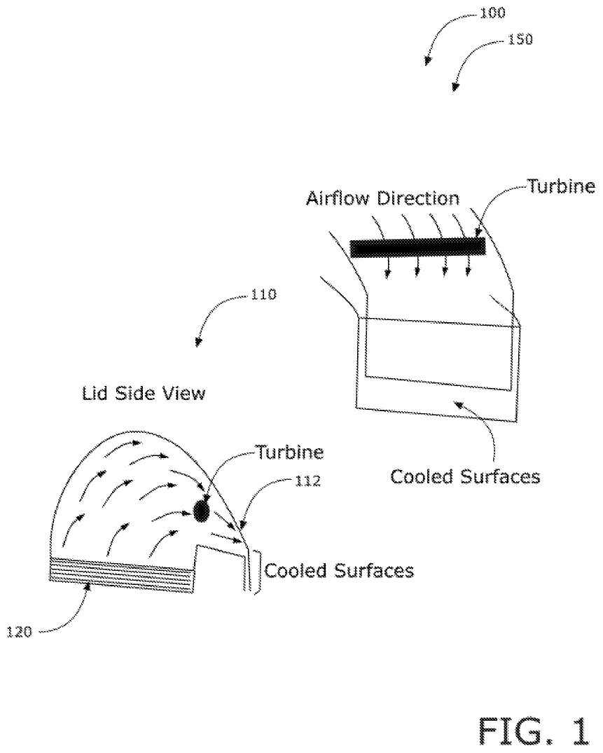

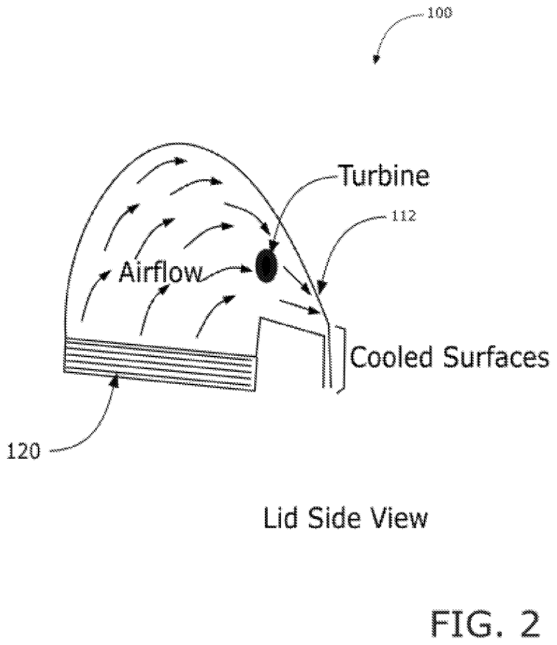

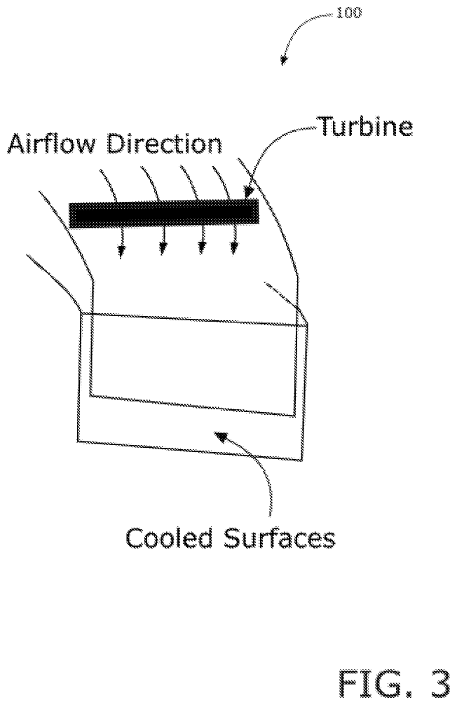

Referring now more specifically to the drawings by numerals of reference, there is shown in FIGS. 1-4, various views of a distillation system 100.

FIG. 1 shows a distillation system 100 during an ‘in-use’ condition 150, according to an embodiment of the present disclosure. Here, the distillation system 100 may be beneficial for use by a user to effectively and efficiently distill contaminates out of liquids and semi-liquids. As illustrated, the distillation system 100 may include in a preferred embodiment: a distillation chamber 110 having a curved and contoured body 112, at least one tube 114 for continuous filling of a liquid solution to be distilled, and at least one drain hole 116 in a bottom of the body 112 configured for removal of concentrated semi-solid contaminants, and multiple layers of sheets 120 of a flexible material. The curved and contoured body's 112 shape of the distillation chamber 110 coupled to a cooled surface near a point of vapors condensation creates negative pressure that drives the distillation process and the negative pressure built into the distillation system 100 facilitates and increases distillation and evaporation rates over conventional means. It should be noted that the negative pressure drives down the boiling temperature to control and increase efficiency in the distillation system 100. The design of the distillation system 100 allows a hard boil to be maintained without having any of the contaminants pass through from bursting/splashing effects of bubbles in the hard boil. Those with ordinary skill in the art will now appreciate that upon reading this specification and by their understanding the art of distilling, liquid movement, appropriate temperature ranges as described herein, methods of distilling and processing of contaminants from the liquids and semi-liquids will be understood by those knowledgeable in such art. Air movement is indicated in relation to the turbine and the curved and contoured body 112.

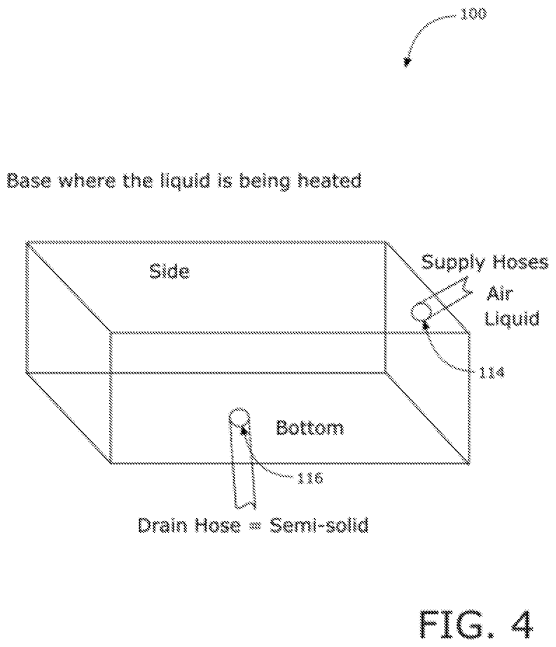

Referring now again to the multiple layers of sheets 120 of a flexible material; the multiple layers of sheets 120 are just above a boiling-water-interface as the cooled surfaces atomize water molecules such that evaporated water vapor does not contain the contaminants. The single water molecules pass through, which prevents formation of water-molecule-clusters in the vapor, which could otherwise preserve ionic effects and trap the contaminants in the water-molecule-clusters. The multiple layers of sheets 120 of the flexible material preferably comprise cloth, or cloth-like material; wherein the cloth does not capture the contaminants. In FIG. 4, the first layer of cloth is placed in this chamber, just above the water level. This is to control the spread of contaminates and limit it to the base chamber.

The multiple layers of sheets 120 of the flexible material act to repeat distillation; wherein a first layer of the multiple layers of sheets 120 of the flexible material acts to moderate the evaporation phase of the distillation process. The multiple layers also amplify the distillation, as previously mentioned for example two layers is effectively equivalent to double-distillation and three layers is effectively equivalent to triple-distillation (using the same amount of energy and time duration as compared to a single distillation process). As such, the contaminants are able to be removed from the liquid solution and alternately from semi liquids; wherein atomizing the water molecules allows the contamination to be spate.

Referring now again to the curved and contoured body 112 of the distillation chamber; the curved and contoured body 112 allows for a convection current to be focused through the cooled surface for rapid condensation which creates a vacuum. The curved and contoured body's 112 shape of the distillation chamber 110 allows for a convection current to be focused through the cooled surface for rapid-condensation which creates the vacuum to increase a rate of evaporation to further increase efficiency and volume of material to be remediated in the distillation system 100. Use of the present invention, distillation system 100, contaminants are able to be removed from the liquid solution and alternately from semi liquids as previously mentioned thus is convenient for use in a variety of industrial applications. The distillation system 100 is suitable for use in alcohol productions, and alternately water purification.

The drain hole 116 at the bottom of the curved and contoured body 112 goes into an insulator/container to solidify waste, wherein the contaminants conveniently become a solid for ease of disposal from the insulator/container. The distillation system 100 is able to run continuously; wherein continuous feeding of the at least one tube 114 allows new the material to be remediated into the distillation system 100 and current creates a continuous self-flow; and wherein the continuous self-flow provides a constant-system.

In one embodiment, the body 112 of the distillation chamber may have a base 2 m×3 m, with the curvature of the body 112 defined as a parabola with an apex height of 2 m. At this size, the tube 114 may be 30 mm in diameter with a 5 mm venting hose for regulating the flow of fluid into the distillation chamber. The drain hole 116 may then be 10 mm in diameter, and coupled via tubing to an isolatable containment system. Additionally, for ease of use, the distillation chamber may be mounted onto a base, in the presently described example, one such suitable base may be 2 m×3 m to support the distillation chamber and 1 m in height to more easily permit access to the distillation system 100.

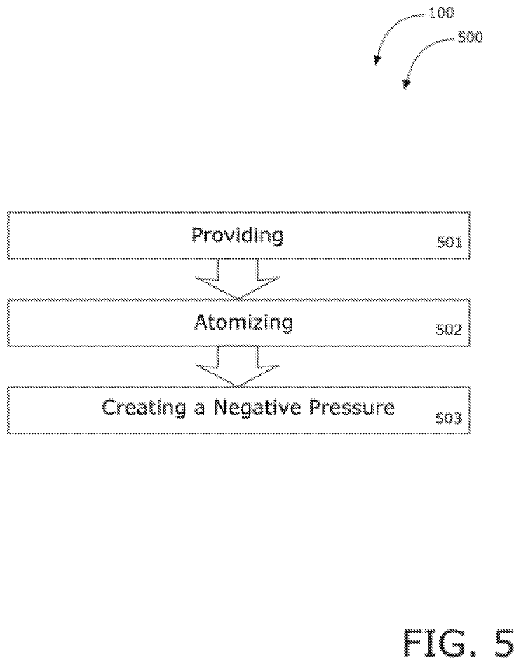

FIG. 5 is a flow diagram illustrating a method of distillation 500 using multiple cloth-like layers such that evaporated water does not contain contaminates using a distillation system 100 in a distillation process, according to an embodiment of the present disclosure. In particular, the method for distillation 500 may include one or more components or features of the distillation system 100 as described above. As illustrated, the method for distillation 500 may include the steps of: step one 501, first providing a distillation system; step two 502, atomizing a solution; step three 503, creating a negative pressure which speeds up the distillation process to increase relative efficiency of the distillation; wherein the distillation system is suitable for use in alcohol productions, and alternately water purification. Upon reading this specification, it should be appreciated that, under appropriate circumstances, considering such issues as user preferences, design preference, structural requirements, marketing preferences, cost, available materials, technological advances, etc., other liquid and semi-liquid distilling and contaminant removal means and applications may be sufficient.

It should also be noted that the steps described in the method of distillation can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for distillation, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A distillation system used for a distillation process comprising:
a distillation chamber having
a curved and contoured body;
at least one tube for continuous filling of a liquid solution to be distilled; and
at least one drain hole in a bottom of the curved and contoured body configured for removal of concentrated semi-solid contaminants; and
multiple layers of sheets of a flexible material separated by a small space between each layer;
wherein the curved and contoured body shape of the distillation chamber coupled to a cooled surface near a point of vapors condensation creates negative pressure that drives the distillation process and the negative pressure built into the distillation system facilitates and increases distillation and evaporation rates;
wherein the multiple layers of sheets of a flexible material are just above a boiling-water-interface as the cooled surfaces to atomize water molecules such that evaporated water vapor does not contain said contaminants;
wherein the curved and contoured body of the distillation chamber allows for a convection current driven by a turbine to be focused through the cooled surface for rapid condensation which creates a vacuum; and
wherein the drain hole at the bottom of the curved and contoured body goes into an insulator/container to solidify waste.

2. The distillation system of claim 1, wherein said contaminants become a solid for ease of disposal from said insulator/container.

3. The distillation system of claim 1, wherein the distillation system is able to run continuously.

4. The distillation system of claim 1, wherein said contaminants are able to be removed from said liquid solution and alternately from semi liquids.

5. The distillation system of claim 1, wherein atomizing the water molecules allows the contamination to be spate.

6. The distillation system of claim 1, wherein the curved and contoured body shape of the distillation chamber allows for a convection current to be focused through the cooled surface for rapid-condensation which creates said vacuum to increase a rate of evaporation to further increase efficiency and volume of material to be remediated.

7. The distillation system of claim 6, wherein continuous feeding of the at least one tube allows new said material to be remediated into the distillation system and current creates a continuous self-flow.

8. The distillation system of claim 7, wherein the continuous self-flow provides a constant-system.

9. The distillation system of claim 1, wherein the multiple layers of sheets of the flexible material comprise cloth.

10. The distillation system of claim 9, wherein the cloth does not capture said contaminants.

11. The distillation system of claim 10, wherein adding more of the multiple layers of sheets of the flexible material act to repeat distillation.

12. The distillation system of claim 11, wherein a first layer of the multiple layers of sheets of the flexible material acts to moderate an evaporation phase of the distillation process.

13. The distillation system of claim 12, wherein the multiple layers also amplify the distillation.

14. The distillation system of claim 13, wherein two said layers is effectively equivalent to double-distillation.

15. The distillation system of claim 13, wherein three said layers is effectively equivalent to triple-distillation.

16. The distillation system of claim 1, wherein the distillation system allows a hard boil to be maintained without having any said contaminants pass through from bursting/splashing effects of bubbles in the hard boil.

17. A distillation system used for a distillation process comprising:
a distillation chamber having
a curved and contoured body;
at least one tube for continuous filling of a liquid solution to be distilled; and
at least one drain hole in a bottom of the curved and contoured body configured for removal of concentrated semi-solid contaminants; and
multiple layers of sheets of a flexible material;
wherein the curved and contoured body shape of the distillation chamber coupled to a cooled surface near a point of vapors condensation creates negative pressure that drives the distillation process and the negative pressure built into the distillation system facilitates and increases distillation and evaporation rates;
wherein the negative pressure drives down the boiling temperature;
wherein the multiple layers of sheets of a flexible material are just above a boiling-water-interface as the cooled surfaces to atomize water molecules such that evaporated water vapor does not contain said contaminants;
wherein single said water molecules pass through, which prevents formation of water-molecule-clusters in the vapor, which could otherwise preserve ionic effects and trap said contaminants in the water-molecule-clusters;
wherein the multiple layers of sheets of the flexible material comprise cloth;
wherein the cloth does not capture said contaminants;
wherein the curved and contoured body of the distillation chamber allows for a convection current to be focused through the cooled surface for rapid condensation which creates a vacuum;
wherein the curved and contoured body shape of the distillation chamber allows for a convection current to be focused through the cooled surface for rapid-condensation which creates said vacuum to increase a rate of evaporation to further increase efficiency and volume of material to be remediated;
wherein said contaminants are able to be removed from said liquid solution and alternately from semi liquids;
wherein the drain hole at the bottom of the curved and contoured body goes into an insulator/container to solidify waste;
wherein said contaminants become a solid for ease of disposal and alternately to recover said contaminates from said insulator/container;
wherein the distillation system is able to run continuously;
wherein continuous feeding of the at least one tube allows new said material to be remediated into the distillation system and current creates a continuous self-flow
wherein the continuous self-flow provides a constant-system.

18. The distillation system of claim 17, wherein the distillation system is suitable for use in alcohol productions, heavy metals remediation and alternately water purification.

19. A method of distillation using multiple cloth-like layers such that evaporated water does not contain contaminates using a distillation system in a distillation process, the method comprising the steps of:
providing a distillation system;
atomizing a solution; and
creating negative pressure which speeds up the distillation process to increase relative efficiency of said distillation.

20. The method of claim 19, wherein the distillation system is suitable for use in alcohol productions, and alternately water purification.
